(19) United States
(12) Patent Application Publication
(10) Pub. No.: US 2014/0188593 A1
(43) Pub. Date: Jul. 3, 2014

(54) SELECTING AN ADVERTISEMENT FOR A TRAFFIC SOURCE

(71) Applicant: Alibaba Group Holding Limited, George Town (KY)

(72) Inventor: Yao Sun, Hangzhou (CN)

(73) Assignee: Alibaba Group Holding Limited, George Town (KY)

(21) Appl. No.: 14/132,620

(22) Filed: Dec. 18, 2013

(30) Foreign Application Priority Data
Dec. 31, 2012 (CN) 201210593825.X

(51) Int. Cl. G06Q 30/02

(52) U.S. Cl. CPC G06Q 30/0242; G06Q 30/0256
USPC 705/14.41

(57) ABSTRACT

Selecting an advertisement for a traffic source including: determining that a current search condition is received at a current traffic source; determining a set of advertising information relevant to the current search condition from an advertising database associated with the current traffic source; determining a predicted probability of a first piece of advertising information of the set of advertising information being selected by a user; determining a predicted probability that user selection of the first piece of advertising information gives rise to a conversion event; determining an attribute parameter for the first piece of advertising information; determining a ranked list of the set of advertising information based at least in part on each piece of advertising information's respective attribute parameter; and selecting a selected piece of advertising information from the set of advertising information.

### CROSS REFERENCE TO OTHER APPLICATIONS

This application claims priority to People's Republic of China Patent Application No. 201210593825.X entitled AN ADVERTISING INFORMATION SEARCHING METHOD AND DEVICE, filed Dec. 31, 2012 which is incorporated herein by reference for all purposes.

### FIELD OF THE INVENTION

The present application relates to the field of processing information associated with advertising. In particular, it relates to selecting advertising information.

### BACKGROUND OF THE INVENTION

The volume of advertisements needed to be served at webpages increases as the prevalence of e-commerce grows. In order to increase advertising efficiency and earnings from website traffic, advertising strategies for network information generally involve optimizing the information publishers used to display advertisements.

Website traffic generally refers to the number of users that visit a website, the number of pages of the website that have been browsed by users, and other such indicators. For an e-commerce website, various kinds of techniques are generally used to draw traffic to the website. Website traffic to an e-commerce website that originates at a webpage that is not associated with the e-commerce website is referred to as external traffic. Website traffic to the e-commerce website that originates from a webpage associated with the website, that occurs as a result of a user directly entering the address of the e-commerce website in the web browser, and that occurs as a result of the user selecting a bookmark associated with the e-commerce website is referred to as on-site traffic. Typically, the conversion rate of external traffic is lower than that of on-site traffic. Thus, in order to evaluate advertising efficiency and to optimize resource allocation for an e-commerce website related advertiser, the traffic from different sources is evaluated for conversion rate related performance. A common conversion rate related evaluation technique for a particular traffic source is the following: to compute a planning coefficient based on a traffic quality associated with the traffic source and to discount each pay per click associated with the traffic source according to a conversion factor. Because the advertising earnings collected by the information publisher from advertiser(s) are discounted by a conversion factor, the earnings collected by an information publisher is sometimes referred to as a discounted pay per click. Then, the unit traffic advertising fees collected by the advertising platform are sometimes referred to as discounted RPMs (revenue per thousand impressions or revenues generated by a thousand searches).

From the perspective of a search engine advertising platform, the higher the revenues are, the better, and the more sustainable the revenues are, the better. Therefore, for each query submitted to the advertising platform of a search engine, the search engine advertising platform will find a set of ads that is relevant to the query. The advertising platform can predict the click-through rate and also compute an ECPM (Expected Cost Per Thousand Impressions or expected revenues per thousand displays)=click-through rate*bid price*1,000 for each relevant ad. Then the search engine advertising platform may rank these relevant ads from high ECPM to low ECPM. The display of relevant ads with higher ECPM is assigned a higher priority (e.g., presented at more conspicuous areas) than relevant ads with lower ECPM because the relevant ads with higher ECPM are predicted to generate the more revenues for the search engine (the information publisher in this example).

As can be seen from the formula for calculating ECPM, ECPM is related to click-through rates and bid prices. Since pay per click fees are used for on-site traffic, using ECPM to rank such traffic can optimize the click revenue per unit traffic. However, research shows that an advertised product's click-through rate is not entirely directly related to its conversion rate. Therefore, prioritizing money spent on advertising at external traffic sources using ECPM may not maximize revenues earned from advertisement.

### BRIEF DESCRIPTION OF THE DRAWINGS

Various embodiments of the invention are disclosed in the following detailed description and the accompanying drawings.

FIG. 1 is a diagram showing an embodiment of a system for selecting an advertisement to display at each of various traffic sources.

FIG. 2 is a flow diagram showing an embodiment of a process for creating a database of advertising information for each traffic source.

FIG. 3 is a flow diagram showing an embodiment of a process for selecting an advertisement for a traffic source.

FIG. 4 is a diagram showing an embodiment of a system for selecting an advertisement for a traffic source.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Embodiments of selecting an advertisement for a traffic source are described herein. In various embodiments, a traffic source is a source from which web traffic to a designated website originates. For example, a traffic source can be another website or a search engine. In various embodiments, the web traffic to the designated website occurs as a result of a user selection of a link displayed at an advertisement that is published at the traffic source. Both the link and the advertisement could also be associated with (e.g., created for or created by) an advertiser associated with the designated website such that a user selection of the link or advertisement will cause the web browser to be directed to a webpage associated with the designated website. As such, in various embodiments, each traffic source is associated with a publisher. In various embodiments, a publisher refers to an entity that can display advertisements among its content.

There are at least two types of traffic to the designated website: external traffic and on-site traffic. As used herein, external traffic refers to traffic to the designated website that originates from a webpage or search engine that is not associated with the designated website. An external traffic source refers to a webpage or search engine that displays an advertisement that once selected by a user, redirects the user to the designated website. As used herein, on-site traffic refers to traffic to the designated website that does not originate from a webpage or a search engine that is not associated with the designated website such as, for example, traffic that occurs as a result of a user directly entering the address of the designated website in a web browser, that occurs as a result of the user selecting a bookmark associated with the designated website, and/or that occurs as a result of a user using a search engine at the designated website.

As will be described below, advertisements associated with the designated website to potentially display at a (external) traffic source are mapped to an advertising database maintained for that traffic source. In response to a current search condition received at a current traffic source, a set of advertisements relevant to the current search condition is found from the advertising database maintained for the current traffic source. An attribute parameter is determined for each advertisement of the set of advertisements. The set of advertisements are ranked based on their respective attribute parameters. At least one advertisement is selected from the ranking to potentially display at the current traffic source with search results returned for the current search condition. For example, the selected advertisement may be submitted (with a bid price) to an advertisement selection system (e.g., an auction) operated by an entity associated with the current traffic source that determines which advertisement(s) to display with search results to be displayed for the current search condition at the current traffic source.

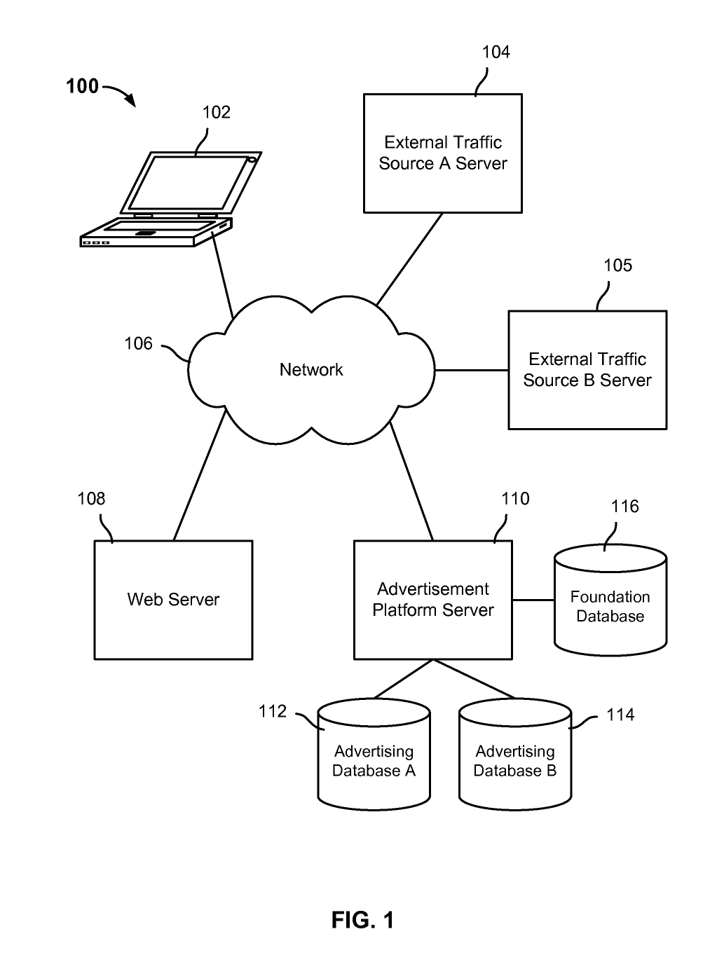

FIG. 1 is a diagram showing an embodiment of a system for selecting an advertisement to display at each of various traffic sources. In the example, system 100 includes client device 102, external traffic source A server 104, external traffic source B server 105, network 106, web server 108, advertisement platform server 110, advertising database A 112, advertising database B 114, and foundation database 116. Network 106 includes high-speed data networks and/or telecommunications networks. Client device 102, external traffic source A server 104, external traffic source B server 105, web server 108, and advertisement platform server 110 may communicate to each other over network 106.

Web server 108 is configured to operate a website. For example, the website is an e-commerce website. The website operated by web server 108 is sometimes referred to as a “designated website.” Advertisement platform server 110 is configured to run advertisement campaigns associated with the designated website of web server 108. Advertisement platform server 110 is configured to obtain traffic information associated with web traffic from one or more traffic sources, such as external source A server 104 and external source B server 105, collected by a third party service (not shown in the diagram). For example, each of external source A server 104 and external source B server 105 is associated with operating a different website or search engine that may present links or advertisements that link to page(s) of the designated website. Each of external source A server 104 and external source B server 105 is a publisher because it publishes content (e.g., advertisements). The obtained traffic information describes historical search conditions submitted at the respective websites/search engines of external source A server 104 and external source B server 105 that have resulted in web traffic to the designated website.

Advertisement platform server 110 is configured to create a corresponding advertising database for each external traffic source identified in the obtained traffic information. An advertising database created for a particular external traffic source includes advertisements to potentially display at that external traffic source. In the example of system 100, the external traffic sources includes at least external source A server 104 and external source B server 105 and so advertisement platform server 110 creates advertising database A 112 for external traffic source A server 104 and advertising database B 114 for external traffic source B server 105. Advertisement platform server 110 is configured to use historical search conditions associated with each external traffic source to determine matching pieces of advertising information from foundation database 116 to copy to the corresponding advertising database of that external traffic source. In various embodiments, foundation database 116 stores pieces of advertising information associated with (e.g., products sold at and/or pages of) the designated website. In various embodiments, a piece of advertising information includes an advertisement and metadata associated with the advertisement. In the example of system 100, advertisement platform server 110 is configured to use historical search conditions of external traffic source A server 104 to match pieces of advertising information stored in foundation database 116 to copy to advertising database A 112 and use historical search conditions of external traffic source B server 105 to match pieces of advertising information stored in foundation database 116 to copy to advertising database B 114.

As will be described in detail below, when a current search condition is submitted at an external traffic source, for example, by a user using client device 102, advertisement platform server 110 is configured to select at least one piece of advertising information corresponding to that external traffic source to potentially display (with the search results returned for the current search condition) at the external traffic source. For example, the selected piece of advertising information may be submitted with a bid price as a bid to an advertisement selection (e.g., auction) system associated with the external traffic source. In the example of system 100, in the event that the current search condition is received at external traffic source A server 104, then advertisement platform server 110 is configured to select at least one piece of advertising information from advertising database A 112 to submit as a bid to be displayed with search results at external traffic source A. In the event that the current search condition is received at external traffic source B server 105, then advertisement platform server 110 is configured to select at least one piece of advertising information from advertising database B 114 to submit as a bid to be displayed with search results at external traffic source B.

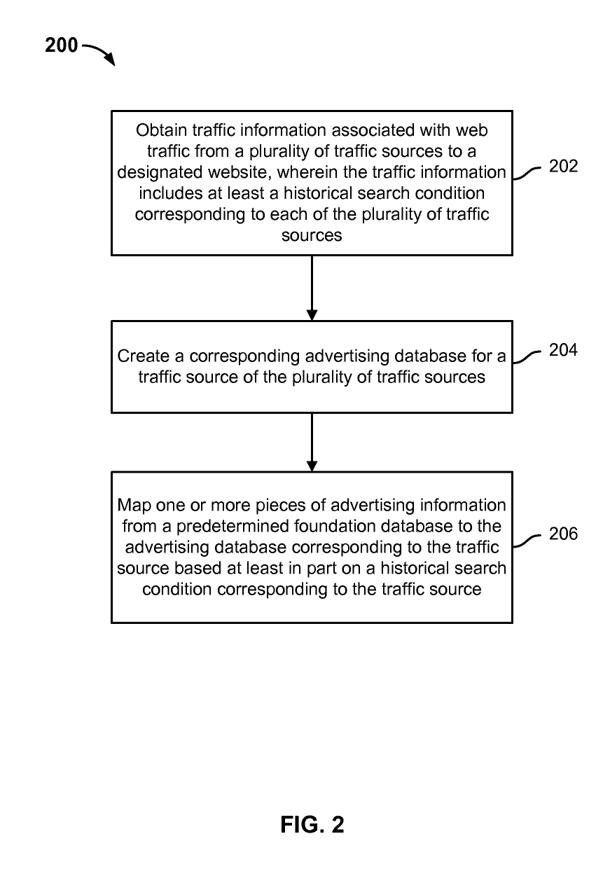

FIG. 2 is a flow diagram showing an embodiment of a process for creating a database of advertising information for each traffic source. In some embodiments, process 200 is implemented at system 100 of FIG. 1.

Process 200 is an example process of creating an advertising database for each of multiple traffic sources from which traffic is directed to a designated website. In some embodiments, the designated website comprises a particular e-commerce website. For example, the designated website is associated with an advertiser or an entity that runs advertisements that link to the designated website. Each traffic source may be associated with a different publisher. In some embodiments, the designated website comprises a publisher that can publish an advertisement associated with the designated website.

At 202, traffic information associated with web traffic from a plurality of traffic sources to a designated website is obtained, wherein the traffic information includes at least a historical search condition corresponding to each of the plurality of traffic sources.

Information associated with web traffic directed to a designated website (e.g., a particular e-commerce website) is obtained. For example, a third-party service may collect and store web traffic information associated with each of various websites. The traffic information associated with the designated website may be acquired from such third-party services.

Obtained traffic information to the designated website may include historical data such as, for example, one or more of the following: sources of the traffic (e.g., from which webpages or website traffic to the designated website originated), a search condition historically submitted at a traffic source that resulted in the traffic to the designated website, the number of users that had visited the designated website, and the number of webpages at the designated website browsed by users.

In some embodiments, the obtained traffic information may include traffic information associated with on-site traffic and external traffic. Example external traffic sources include forums, blogs, social media websites, micro-blogs, video websites, and search engines that are not associated with the designated website. Example on-site traffic refers to traffic that comes from directly entering the designated website's URL (Uniform Resource Locator) into a web browser, a user selection of a bookmark, or by a user submitting a search query at a search engine of the designated website (an on-site search engine). For example, when a user searches for keywords directly through the designated website's on-site search engine and then selects (e.g., clicks) any link to a web page of the designated website within the search results, the traffic generated is considered as on-site traffic. In various embodiments, each different external traffic source is identified from the obtained traffic information.

Examples of search conditions included in the obtained traffic information include one or more of the following: user-entered search conditions, user information, and traffic source attributes. Where a traffic source includes a search engine, the search conditions entered by the user may include keywords, search categories, search attributes, product brands, models, styles, and/or prices. A search condition included in the traffic information includes a search condition for which a returned search result was associated with the designated website.

Examples of user information associated with search conditions included in the obtained traffic information include one or more of the following: user status (e.g., whether or not a registered member at the traffic source website), user age, sex, occupation, income range, (which may be obtained from user account/profile information), and geographic location (which may be obtained based on networking packet headers sent by the user).

Examples of traffic source attributes associated with search conditions included in the obtained traffic information include one or more of the following: the type of a traffic source website and a degree to which user status at the traffic source website overlaps with e-commerce website membership status.

At 204, a corresponding advertising database is created for a traffic source of the plurality of traffic sources. In various embodiments, a corresponding advertising database is created and/or initialized for each identified external traffic source from the obtained traffic information. In some embodiments, the advertising database created for each external traffic source will be used to store pieces of advertisement information to be published at that traffic source. Each piece of advertisement information includes at least an advertisement (e.g., designed to be associated with the designated website and/or links back to the designated website in response to a user selection) and metadata associated with the advertisement. In some embodiments, more than one advertising database may be maintained/initialized for each external traffic source.

At 206, one or more pieces of advertising information are mapped from a predetermined foundation database to the advertising database corresponding to the traffic source based at least in part on a historical search condition corresponding to the traffic source.

In order to take into account the advertising results of different traffic sources (e.g., publishers), in various embodiments, the advertisements to be published at each different traffic source is mapped and/or stored in the advertising database maintained for that traffic source. Therefore, as will be described further below, advertisements mapped to (advertising database of) the same traffic source (publisher) will be ranked against each other at a time when an advertisement is to be selected to be displayed at that traffic source (versus being ranked against advertisements mapped to different traffic sources).

In various embodiments, a piece of advertisement information includes at least an advertisement and metadata associated with the advertisement. In some embodiments, a piece of advertisement information is created by an advertiser (e.g., the owner of the designated website) and/or a party that manages the advertisement campaigns of the advertiser. In various embodiments, an advertisement can include one or more of the following: advertising category attribute textual descriptions, purchase bid keywords, bids for bid keywords, advertising budgets, advertising titles, advertising pictures, and other creative aspects of advertisements (e.g., the content to be displayed as part of the advertisement such as images, prices, discount information, geographic location information, etc.). Metadata associated with an advertisement can include one or more of the following: a title of a product information page to which a user selection of the advertisement will link, a product category associated with the advertisement, a product attribute associated with the advertisement, and descriptions on a product information page associated with the advertisement.

All pieces of advertising information to be mapped to various advertising databases corresponding to respective ones of traffic sources can be stored in one or more predetermined foundation database(s). When the advertising databases are to be populated with matching pieces of advertising information from the predetermined foundation database, the pieces of advertising information stored in the predetermined foundation database are compared to the historical search conditions (determined from the obtained traffic information) associated with each different traffic source. Pieces of advertising information stored in the predetermined foundation database that match the historical search condition(s) of a particular traffic source are copied to the advertising database maintained for that traffic source. A piece of advertising information may be mapped (and copied) to more than one advertising database, each corresponding to a different traffic source.

In some embodiments, historical advertising feedback data collected regarding each traffic source is also stored at the advertising databases corresponding to the traffic source. The historical advertising feedback data for each traffic source may be obtained from the same or a different third party service than the one from which the traffic information was obtained. Advertising feedback data may comprise product display and click activity as well as user conversion activity (such as bookmarking or purchasing events) that occurred subsequent to the display and selection of historically displayed advertisements associated with the designated website.

In conventional techniques, advertisements to be published at various different external traffic sources are stored in the same database. Furthermore, different external traffic sources were ranked for a designated website and the designated website's allocation of resources towards advertisements at the external traffic sources was prioritized with respect to the ranking of the external traffic source at which they would be published. Put another way, the allocation of resources towards an advertisement was dependent on the ranking of the external traffic source at which the advertisement would be published. For example, assume that using conventional techniques, a historical set of traffic information to the designated website was analyzed to determine rankings of external traffic sources A and B and external traffic source A was ranked higher than external traffic source B. Thus, based on the conventional techniques, at subsequent opportunities to allocate resources for advertisements at external traffic sources A and B, more resources would be allocated for advertising at external traffic source A than external traffic source B. However, it is possible that over time, advertisements at external traffic source B yields more earnings than external traffic source A, yet based on the previously determined rankings, more resources are still dedicated to external traffic source A than B, which is unfair to external traffic source B. As such, conventional techniques do not separately rank advertisements with respect to each external traffic source but rather rank entire external traffic sources, which may not allow for the optimization of resource allocation of advertisement resources for the designated website.

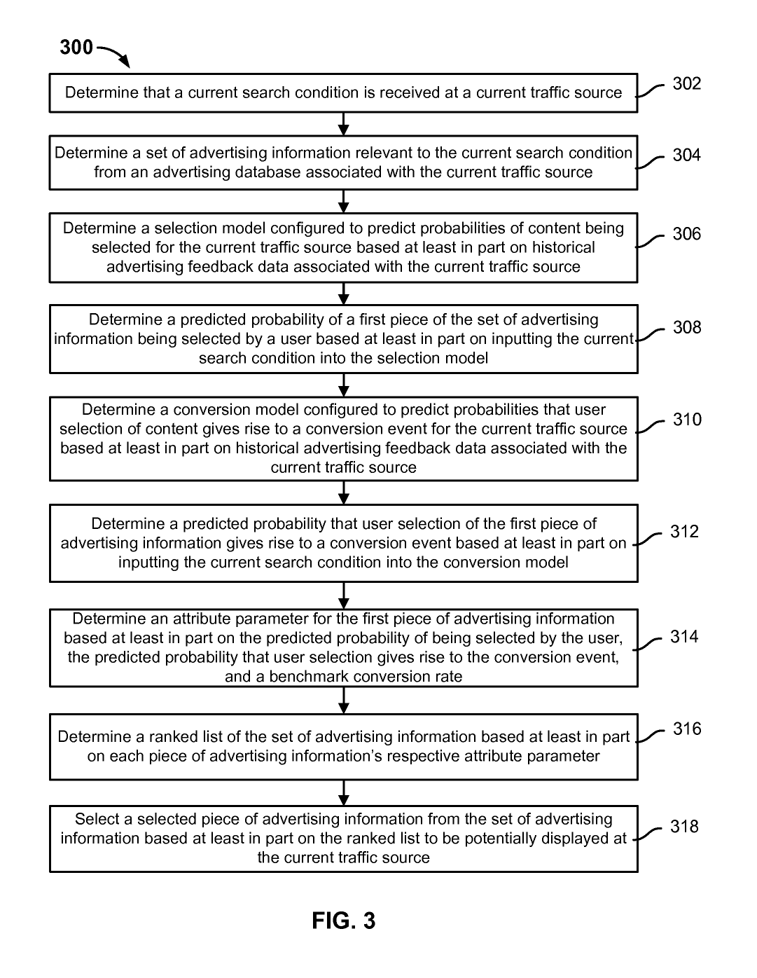

FIG. 3 is a flow diagram showing an embodiment of a process for selecting an advertisement for a traffic source. In some embodiments, process 300 is implemented at system 100 of FIG. 1.

Process 300 describes an example process of selecting an advertisement to use as a bid by a particular advertiser at an external traffic source for which an advertisement presentation opportunity arises (e.g., a current search condition is received at the traffic source). For example, bids are to be evaluated for the traffic source to determine which one or more advertisements are to be displayed on the search results page to be returned by the traffic source for the current search condition. In process 300, the advertiser for which an advertisement is selected is associated with a designated website for which advertising databases corresponding to respective traffic sources were established using a process such as process 200 of FIG. 2. Process 300 may be performed by an entity associated with the designated website.

At 302, a current search condition is determined to be received at a current traffic source.

In various embodiments, an advertisement presentation opportunity arises at an external traffic source when a predetermined event occurs. An example of such a predetermined event for which an advertisement presentation opportunity arises is when a search condition is received at the external traffic source and an advertisement is needed to be displayed with the search results to be returned for the search condition. For example, the search condition may be received at a search engine of the external traffic source. The search condition may include one or more search keywords and/or other user selections, for example.

In process 300, the (external) traffic source at which the search condition is received is referred to as the “current traffic source” and the search condition received at the current traffic source is referred to as the “current search condition.”

At 304, a set of pieces of advertising information relevant to the current condition is determined from an advertising database associated with the current traffic source.

In various embodiments, an advertising database is pre-established (e.g., using a process such as process 200 of FIG. 2) corresponding to each traffic source for the designated website. For example, mappings between traffic sources and corresponding advertising databases may be stored and retrieved to determine identifying information of the advertising database corresponding to the current traffic source. The advertising database that has been pre-established for the current traffic source is accessed (e.g., using the determined identifying information) and searched for a set of pieces of advertising information that is relevant (e.g., matches at least in part) to the current search condition. The set of pieces of advertising information that is relevant to the current search condition comprises the candidate pieces of advertising information from which a piece of advertisement to use as a bid for the advertiser associated with the designated website is selected.

In various embodiments, an advertising database corresponding to a traffic source also stores historical advertising feedback data collected for that traffic source. For example, advertising feedback data includes activity information that occurs after advertisements have been presented at a traffic source. For example, advertising feedback data may comprise product display and selection (e.g., click) activity of advertisements that were displayed at the traffic source as well as user conversion activity that occurred subsequent to display and click activity. In various embodiments, conversion activity includes at least purchasing a product associated with a selected advertisement or a bookmarking selection of a product associated with the selected advertisement. In some embodiments, the activity information is statistically analyzed to obtain advertising feedback data such as the bounce rate of the detailed product information page. The bounce rate indicates the ratio of the number of visits by users that enter the designated website through an appropriate portal (e.g., advertisement, keywords, catalog, etc.) and then leave after visiting only one page to the total number of visits via that portal. A smaller bounce rate represents greater website popularity and greater willingness on the part of users to visit more pages. Conversely, a larger value indicates that the website is less popular. The bounce rate can be used to evaluate the quality of a website's login page, for example.

In some embodiments, the historical advertising feedback data is stored separately from the advertising database corresponding to a traffic source.

As will be described in detail below, the historical advertising feedback data of the current traffic source is used to determine a certain attribute parameter (the discounted expected revenue parameter or D ECPM) for each candidate piece of advertisement information. At least one piece of advertisement information is selected to use as bid(s) based on its respective attribute parameters.

At 306, a selection model configured to predict probabilities of content being selected is determined for the current traffic source based at least in part on historical advertising feedback data associated with the current traffic source.

A selection model is determined for the current traffic source based at least in part on the historical advertising feedback data of the current traffic source. The selection model is configured to predict the probability that a piece of advertisement is to be selected (e.g., clicked) by a user when displayed at a traffic source for various different search conditions (submitted at the traffic source). Thus, the selection model determined for the current traffic source may be used to predict the probability of a piece of advertising information being selected (e.g., when displayed with search results returned for the current search condition) for the current search condition received at the current traffic source.

A selection model for the current traffic source may be determined by interpreting search engine click logs of the current traffic source. In some embodiments, a selection model may be constructed as a Dynamic Bayesian Network model (DBN). Each technique of model construction puts forward its own assumptions that are used to explain the searching and browsing behaviors of users. Each model construction also uses a type of machine learning algorithms for parameter evaluation. Parameter evaluation algorithms play a very key role in the process whereby models accurately interpret click behavior. If different parameter evaluation algorithms are used on the same model, the results may end up being different.

The predicted probability of being selected for a piece of advertising information is also sometimes referred to as the predicted click-through rate of that piece of advertising information. The click-through rate is the ratio of the number of clicks on a certain piece of content on a web page to the total number of times that it is displayed. The click-through rate of a piece of advertising information reflects the level of attention paid to the piece of advertising information and is often used to measure the quality of advertising information.

At 308, a predicted probability of a first piece of the set of pieces of advertising information being selected by a user is determined based at least in part on inputting the current search condition into the selection model.

In various embodiments, the selection model determined for the current traffic source is used to predict the probability for each candidate piece of advertising information of the set of pieces of advertising information for the current search condition to be selected (e.g., clicked) by a user (e.g., when displayed with search results returned for the current search condition).

The following is an example formula to use to determine the selection model to predict the probability of being selected (e.g., the click-through rate) for a candidate piece of advertising information of the set of pieces of advertising information for the current search condition received at the current traffic source:

CTR=f(query, Ad_info, refPID_info, user_info, ad_feedback) (1)

where:

CTR is the predicted probability of the candidate piece of advertising information being selected by a user for a certain search condition being received at the current traffic source;

query is the historical search condition information at the current traffic source;

Ad_info is the historical advertising information corresponding to the current traffic source;

refPID_info is the historical traffic information, including a type of the website of the traffic source and the degree of overlap between the current traffic source with the designated website's membership;

user_info is the historical user information associated with the user that submitted the certain search condition at the current traffic source;

ad_feedback is the historical advertising feedback at the current traffic source.

As shown in the above formula, CTR, the predicted probability of being selected is determined as a function of the following inputs/parameters: query, Ad_info, refPID_info, user_info, and ad_feedback. Thus, a CTR value may be predicted for given a set of query, Ad_info, refPID_info, user_info, and ad_feedback values. At least some of the query, Ad_info, refPID_info, user_info, and ad_feedback values may be determined from the current search condition, the candidate piece of advertising information, the current traffic source, and/or the user that submitted the current search condition, for example.

The selection model may be determined by using historical selection (e.g., click) data as the training data for a machine learning technique. A simple example of a machine learning technique is linear regression. Application of linear regression to the historical selection data may arrive at an expression (the selection model) that determines the relationships among the query, Ad_info, refPID_info, user_info, and ad_feedback parameters to determine a CTR value. The following example expression may be determined by linear regression and be used as a selection model:

CTR=w1*query+w2*Ad_info+w3*refPID_info+w4*user_info+w5*ad_feedback (2)

Where w1, w2, w3, w4, and w5 are weights determined by the linear regression machine learning technique. The selection model is established to predict the probability of being selected (e.g., the click-through rate) for each candidate piece of advertising information for a certain query submitted by a user to the current traffic source. To use expression (2) as an example selection model, known values of query, Ad_info, refPID_info, user_info, and ad_feedback associated with a candidate piece of advertising information are input into expression (2) to determine the unknown CTR value (the predicted probability of the candidate piece of advertising information being selected by a user).

At 310, a conversion model configured to predict probabilities that user selection of content gives rise to conversion events is determined for the current traffic source based at least in part on the historical advertising feedback data associated with the current traffic source.

A conversion model is determined for the current traffic source based at least in part on the historical advertising feedback data of the current traffic source. The conversion model is configured to predict the probability that a piece of advertisement is to be selected (e.g., clicked) by a user when displayed at a traffic source and give rise to a conversion event (e.g., at the designated website) for various different search conditions (submitted at the traffic source). Thus, the conversion model determined for the current traffic source may be used to predict the probability of a piece of advertising information being selected (e.g., when displayed with search results) for the current search condition received at the current traffic source and then give rise to a conversion event. Examples of conversion events may include: purchasing an item at the designated website, registering as a new member at the designated website, forwarding a page associated with an item at the designated website, and bookmarking a page associated with the designated website.

At 312, a predicted probability that user selection of the first piece of advertising information gives rise to a conversion event is determined based at least in part on inputting the current search condition into the conversion model.

In various embodiments, the conversion model determined for the current traffic source is used to predict the probability for each candidate piece of advertising information of the set of pieces of advertising information for the current search condition to be selected (e.g., among search results) and to give rise to the conversion event.

The following is an example formula to use to determine the conversion model to use to predict the probability for a candidate piece of advertising information of the set of pieces of advertising information being selected and give rise to a conversion event for the current search condition received at the current traffic source:

p=g(query, Ad_info, refPID_info, user_info, Ad_feedback) (3)

where:

p is the predicted probability that user selection of a piece of advertising information gives rise to a conversion event for a certain search condition being received at the current traffic source;

query is the historical search condition information at the current traffic source;

Ad_info is the historical advertising information corresponding to the current traffic source;

refPID_info is historical traffic information, including a type of the website of the traffic source and the degree of overlap between the current traffic source with the designated website's membership;

user_info is the historical user information associated with the user that submitted the certain search condition at the current traffic source;

Ad_feedback is the historical advertising feedback data at the current traffic source and the advertising feedback data at the on-site traffic source (the designated website itself).

As shown in the above formula, p, the predicted probability that a piece of advertising information is to be selected and give rise to a conversion event is determined as a function of the following inputs/parameters: query, Ad_info, refPID_info, user_info, and Ad_feedback. Thus, a p value may be predicted for given a set of query, Ad_info, refPID_info, user_info, and Ad_feedback values. At least some of the query, Ad_info, refPID_info, user_info, and Ad_feedback values may be determined from the current search condition, the candidate piece of advertising information, the current traffic source, and/or the user that submitted the current search condition, for example.

The selection model may be determined by using historical conversion data as the training data for a machine learning technique. A simple example of a machine learning technique is linear regression. Application of linear regression to historical conversion data may arrive at an expression (the conversion model) that determines the relationships among the query, Ad_info, refPID_info, user_info, and ad_feedback parameters to determine a p value. The following example expression may be determined by linear regression and be used as a conversion model:

p=m1*query+m2*Ad_info+m3*refPID_info+m4*user_info+m5*Ad_feedback (4)

Where m1, m2, m3, m4, and m5 are weights determined by the linear regression machine learning technique. The conversion model is established to predict the probability of being selected and give rise to a conversion event for each candidate piece of advertising information for a certain query submitted by a user to the current traffic source. To use expression (4) as an example conversion model, known values of query, Ad_info, refPID_info, user_info, and Ad_feedback associated with a candidate piece of advertising information are input into expression (4) to determine the unknown p value (predicted probability that a piece of advertising information is to be selected and give rise to a conversion event).

At 314, an attribute parameter is determined for the first piece of advertising information based at least in part on the predicted probability of being selected by the user, the predicted probability that user selection gives rise to the conversion event, and a predetermined benchmark conversion rate.

The predicted probability of being selected determined for a piece of advertising information of the set of pieces of advertising information, the predicted probability of being selected and giving rise to a conversion event for the piece of advertising information, and a predetermined benchmark are used to determine an attribute parameter for that piece of advertising information. The attribute parameter may be determined for each piece of advertising information of the set of pieces of advertising information. In various embodiments, the attribute parameter is the discounted expected revenue parameter (D_ECPM) that may be determined for each piece of advertising information of the set of pieces of advertising information.

The following is an example formula for determining the D_ECPM for a piece of advertising information for a current search condition received at the current traffic source:

D_{—}ECPM=ECPM*(ad CVR/benchmark CVR) (5)

where:

D_ECPM is the discounted expected avenue parameter (the attribute parameter) for a piece of advertising information;

ECPM is the predicted expected revenue per thousand displays for the piece of advertising information. In various embodiments, ECPM=CTR*bid (where CTR may be determined by a formula such as formula (1) of step 308 and where bid is the advertising bid price for the current traffic source).

ad CVR (advertisement conversion rate) is the predicted probability that user selection of the piece of advertising information gives rise to a conversion event (e.g., a purchase of an item at the designated website, registering as a new member at the designated website, forwarding a page associated with an item at the designated website, and bookmarking a page associated with an item at the designated website) for the current search condition at the current traffic source. In various embodiments, ad CVR=p (where p may be determined by a formula such as formula (3) of step 312).

benchmark CVR is the predetermined benchmark conversion rate of traffic that serves as a reference. The predetermined benchmark conversion rate may be set as the historical conversion rate of a particular type of traffic. In various embodiments, the predetermined benchmark conversion rate can be set as the historical conversion rate of the designated website's own on-site traffic. The historical conversion rate of the designated website's own on-site traffic is the conversion rate of advertisements associated with the designated website that have been displayed at the designated website (rather than a traffic source external to the designated website). Because the designated website itself can be a publisher of advertisements and also be associated with an advertiser of at least some such advertisements, sometimes a user selection of an advertisement presented at the designated website links to another page of the designated website. Generally, the on-site traffic (e.g., traffic to a page of the designated website that originates from a page at the designated website) is considered as a superior quality traffic to external traffic (e.g., traffic to a page of the designated website that originates from a page external to the designated website) and therefore historical conversion rate of on-site traffic may be used as the predetermined benchmark conversion rate (benchmark CVR). In some embodiments, the predetermined benchmark conversion rate may be set as the historical conversion rate of another type of high-quality traffic other than on-site traffic.

Given that ECPM=(CTR*bid) and ad CVR can be represented by the predicted probability of being selected and giving rise to a conversion event p (as determined at step 312), formula (3) may be rewritten as:

D_{—}ECPM=(CTR*bid)*(p/benchmark CVR) (6)

=CTR*bid*p/benchmark CVR; (7)

As shown by formula (7), D_ECPM for a piece of advertising information can be determined using the predicted probability of the piece of advertising information being selected by a user for the current search condition at the current traffic source, the predicted probability that user selection of the piece of advertising information being selected gives rise to a conversion event for the current search condition at the current traffic source, and the predetermined benchmark conversion rate.

Conventional advertisement ranking techniques generally make use of ECPM to perform rankings ECPM refers to the advertising revenue that can be gained from every one thousand displays of an advertisement. A display unit may be a web page, an advertising information element, or even a single piece of advertising information. As mentioned above, the ECPM of an advertisement can be represented as ECPM=advertising unit bid price*advertising click-through rate *1000. This expression shows that the advertising profitability trend of a website is unrelated to the size of a website and is instead decided by the mean advertising unit price and the advertising click-through rate. When advertising quality is poor, the advertising's click-through rate value will be very small. Where the advertisement rank is improved by raising the advertising unit bid price but not by improving the quality of the advertising, the user's experience upon seeing this kind of advertisement will suffer.

Embodiments described herein use the ratio of the predicted probability of a piece of advertising information being selected and giving rise to a conversion event at an external traffic source to the predetermined benchmark conversion rate (ad CVR/benchmark CVR) as a discount factor for a piece of advertising information to be published at the external traffic source. The ECPM determined for the piece of advertising information to be published at an external traffic source can be thought of as being weighted (e.g., multiplied) by the discount factor associated with the piece of advertising information associated with that external traffic source. Because the benchmark conversion rate is based on a high conversion rate, the higher the predicted conversion probability of a piece of advertising information at an external source, the greater the attribute parameter (discounted expected revenue parameter or D_ECPM) determined for the piece of advertising information will be. Conversely, the lower the predicted conversion probability of a piece of advertising information at an external source, the lower the attribute parameter (discounted expected revenue parameter or D_ECPM) determined for the piece of advertising information will be.

When search conditions are received at different traffic sources, the pieces of advertising information corresponding to each traffic source that match the respective search condition are ranked in the context of the corresponding traffic source. Because each traffic source corresponds to an advertising database that includes pieces of advertising information that have been determined to match historical search conditions received at that traffic source, advertising databases that correspond to different traffic sources may include different pieces of advertising information. Thus, within different advertising databases (that correspond to different traffic sources), the attribute parameter (D_ECPM) determined for pieces of advertising information that match to a search condition will likely be different. Therefore, the rank of a particular piece of advertising information may vary depending on which advertising database (traffic source) for which it is being ranked.

Since each traffic source corresponds to its own advertising database, the attribute parameter D_ECPM of each piece of advertising information determined for each external traffic source will, as a result of the differences among external traffic source information and advertising feedback data for different traffic sources, be different even if the search conditions, user information, advertising information, and other such factors are the same. As a result, the same piece of advertising information may rank differently among other pieces of advertising information in different advertising databases even for the same current search condition. As described above, a corresponding advertising database is organized for each traffic source (publisher) so that pieces of advertising information may be ranked and selected to be potentially displayed within the context of each traffic source, rather than across all traffic sources.

Thus, the attribute parameter determined for each piece of advertising information is dependent on the traffic source to which it corresponds and so pieces of advertising information corresponding to the same traffic source may be ranked against each other based on their respective D_ECPM values at an opportunity to present a piece of advertising information at the traffic source.

At 316, a ranked list of the set of advertising information is determined based at least in part on each piece of advertising information's respective attribute parameter.

The set of the pieces of advertising information are ranked according to their respective attribute parameters (D_ECPM values) from the piece of advertising information with the highest D_ECPM to the piece of advertising information with the lowest D_ECPM. A piece of advertising information with the highest D_ECPM is predicted to yield the highest earnings for the advertiser associated with the designated website within the context of the conversion ability of the current traffic source.

At 318, a selected piece of advertising information from the set of advertising information is selected based at least in part on the ranked list to be potentially displayed at the current traffic source.

In some embodiments, at least one piece of advertising information from the ranked list is selected to be potentially published at the current traffic source. For example, one or more pieces of advertising information associated with the highest attribute parameter (D_ECPMs) from the ranked list may be selected. The selected one or more pieces of advertising information may each be submitted with a bid price (e.g., determined by the advertiser and/or other party) to the advertisement selection system associated with the current traffic source. In various embodiments, the advertisement selection system associated with the current traffic source ultimately determines which advertisement(s) to serve with the search results for the current search condition at the current traffic source using its own advertising selection techniques. For example, the advertisement selection system associated with the current traffic source may use an auction to determine which advertisement(s) to display at the search results page. The piece(s) of advertising information selected based on their respective D_ECPMs represent the piece(s) of advertising information that are predicted to yield the greatest earnings (greatest relative conversion probabilities) to the advertiser associated with the designated website from the current traffic source.

In some embodiments, in the case of on-site traffic, ECPM is used to rank advertisements to potentially display at the designated website but in the case of off-site (external) traffic, D_ECPM is used to rank advertisements to potentially display at the external traffic sources. Advertisements to potentially display at external traffic sources are ranked from high to low according to D_ECPM.

Below are some examples of ranking pieces of advertising information associated with different traffic sources:

### EXAMPLE 1

On-site traffic, which is regarded as a benchmark (the designated website's own traffic):

query (current search condition)=xyz;

user that submitted the query=a;

the pieces of advertising information matched from the advertising database associated with the designated website: A, B, C, D;

the ECPM values corresponding to the respective advertising information: 10, 8, 6 and 4;

Based on the ECPM values, the pieces of advertising information are ranked in the following order: ABCD. In this example, piece of advertising information A may be selected to be potentially displayed on-site at the designated website.

### EXAMPLE 2

On external traffic source 1:

query (current search condition)=xyz;

user that submitted the query=b;

the pieces of advertising information matched from the advertising database associated with the designated website: A, B, C, D;

the D_ECPM values corresponding to the respective advertising information: 5, 8, 6 and 3;

Based on the D_ECPM values, the pieces of advertising information are ranked in the following order: BCAD. In this example, piece of advertising information B may be selected to be potentially displayed at external traffic source 1.

### EXAMPLE 3

On external traffic source 2:

query (current search condition)=xyz;

user that submitted the query =c;

the pieces of advertising information matched from the advertising database associated with the designated website: A, B, C, D;

the D_ECPM values corresponding to the respective advertising information: 7, 9, 1 and 5;

Based on the D_ECPM values, the pieces of advertising information are ranked in the following order: BADC. In this example, piece of advertising information B may be selected to be potentially displayed at external traffic source 2.

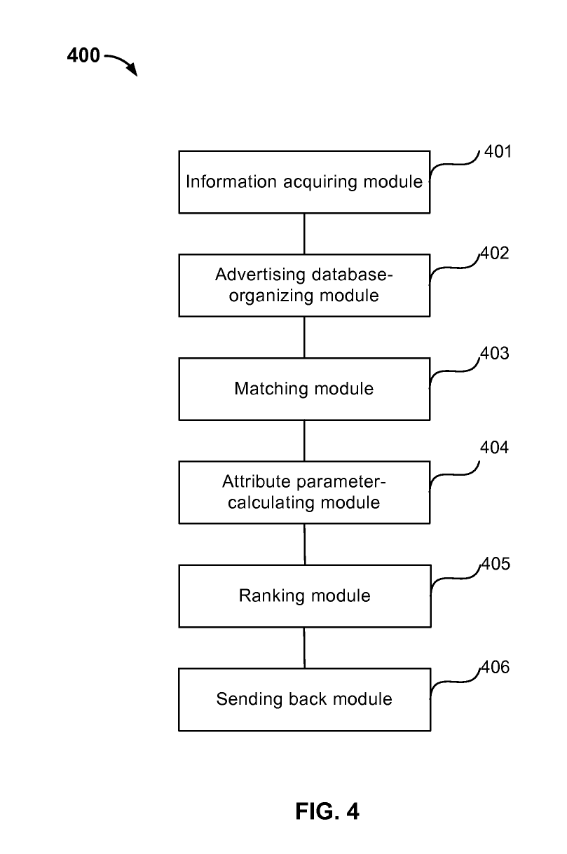

FIG. 4 is a diagram showing an embodiment of a system for selecting an advertisement for a traffic source. In the example, system 400 includes information acquiring module 401, advertising database-organizing module 402, matching module 403, attribute parameter-calculating module 404, ranking module 405, and sending back module 406.

The modules and sub-modules can be implemented as software components executing on one or more processors, as hardware such as programmable logic devices and/or Application Specific Integrated Circuits designed to elements can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The modules and sub-modules may be implemented on a single device or distributed across multiple devices.

Information acquiring module 401 is configured to obtain traffic information associated with web traffic from a plurality of traffic sources to a designated website. The traffic information may include at least historical search conditions associated with each traffic source, user information, and traffic source attributes.

Advertising database-organizing module 402 is configured to use the obtained traffic source information to create an advertising database for each traffic source. In some embodiments, an advertising database is created for each external traffic source. The advertising database corresponding to a traffic source includes pieces of advertising information associated with the designated website that will potentially be displayed at that traffic source.

Matching module 403 is configured to determine pieces of advertising information that match the historical search conditions of a traffic source to include in the advertising database created for that traffic source.

Attribute parameter-calculating module 404 is configured to calculate the attribute parameter for each piece of advertising information of a set of pieces of advertising information from the advertising database of a current traffic source determined to match a current search condition received at the current traffic source.

In some embodiments, attribute parameter-calculating module 404 may include the sub-modules below:

A selection model establishing sub-module that is configured to determine a selection model configured to predict probabilities of content being selected for the current traffic source based at least in part on historical advertising feedback data associated with the current traffic source. A predicted probability of being selected at the current traffic source for the current search condition may be determined for each piece of advertising information of the set of pieces of advertising information.

A conversion model establishing sub-module that is configured to determine a conversion model configured to predict probabilities of content being selected and give rise to conversion events for the current traffic source based at least in part on the historical advertising feedback data associated with the current traffic source. A predicted probability of being selected at the current traffic source and giving rise to a conversion event for the current search condition may be determined for each piece of advertising information of the set of pieces of advertising information.

An attribute parameter calculating sub-module that is configured to determine an attribute for each piece of advertising information of the set of pieces of advertising information based at least in part on the piece of advertising information's probability of being selected at the current traffic source for the current search condition, probability of being selected at the current traffic source and giving rise to a conversion event for the current search condition, and a predetermined benchmark conversion rate.

Ranking module 405 is configured to rank the set of pieces of advertising information according to their respective attribute parameters from pieces of advertising information with the highest attribute parameters to pieces of advertising information with the lowest attribute parameters.

Sending back module 406 is configured to select at least one piece of advertising information associated with a higher attribute parameter to be potentially displayed at the current traffic source.

A person skilled in the art should understand that the embodiments of the present application can be provided as methods, systems or computer software products. Therefore, the present application can take the form of embodiments consisting entirely of hardware, embodiments consisting entirely of software, and embodiments which combine software and hardware. In addition, the present application can take the form of computer program products implemented on one or more computer-operable storage media (including but not limited to magnetic disk storage devices, CD-ROM, and optical storage devices) containing computer operable program codes.

The present application is described with reference to flow charts and/or block diagrams based on methods, equipment (systems) and computer program products. It should be understood that each process and/or block in the flow charts and/or block diagrams, and combinations of processes and/or blocks in the flow charts and/or block diagrams, can be achieved through computer program commands. One can provide these computer commands to a general-purpose computer, a specialized computer, an embedded processor or the processor of other programmable data processing equipment so as to give rise to a machine, with the result that the commands executed through the computer or processor of other programmable data processing equipment give rise to a device that is used to realize the functions designated by one or more processes in a flow chart and/or one or more blocks in a block diagram.

These computer program commands can also be stored on specially-operating computer-readable storage devices that can guide computers or other programmable data processing equipment, with the result that the commands stored on these computer-readable devices give rise to products that include command devices. These command devices realize the functions designated in one or more processes in a flow chart and/or one or more blocks in a block diagram.

These computer program commands can also be loaded onto a computer or other programmable data processing equipment, with the result that a series of operating steps are executed on a computer or other programmable equipment so as to give rise to computer processing. In this way, the commands executed on a computer or other programmable equipment provide steps for realizing the functions designated by one or more processes in a flow chart and/or one or more blocks in a block diagram.

Although embodiments of the present application have been described above, a person skilled in the art can make other modifications or revisions to these embodiments once he grasps the basic creative concept. Therefore, the attached claims are to be interpreted as including the preferred embodiments as well as all modifications and revisions falling within the scope of the present application.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
one or more processors configured to:
determine that a current search condition is received at a current traffic source;
determine a set of advertising information relevant to the current search condition from an advertising database associated with the current traffic source;
determine a predicted probability of a first piece of the set of advertising information being selected by a user based at least in part on inputting the current search condition into a selection model;
determine a predicted probability that user selection of the first piece of the set of advertising information gives rise to a conversion event based at least in part on inputting the current search condition into a conversion model;
determine an attribute parameter for the first piece of the set of advertising information based at least in part on the predicted probability of being selected by the user, the predicted probability that user selection gives rise to the conversion event, and a predetermined benchmark conversion rate;
determine a ranked list of the set of advertising information based at least in part on each piece of advertising information's respective attribute parameter; and
select a selected piece of advertising information from the set of advertising information based at least in part on the ranked list to be potentially displayed at the current traffic source; and
one or more memories coupled to the one or more processors configured to provide instructions to the one or more processors.

2. The system of claim 1, wherein the current traffic source comprises an external traffic source associated with a designated website.

3. The system of claim 1, wherein the one or more processors are further configured to determine the advertising database associated with the current traffic source including by:
obtaining traffic information associated with web traffic from a plurality of traffic sources to a designated website, wherein the traffic information includes at least a historical search condition corresponding to each of the plurality of traffic sources, wherein the plurality of traffic sources includes the current traffic source;
creating the advertising database for the current traffic source; and
mapping one or more pieces of advertising information from a predetermined foundation database to the advertising database corresponding to the current traffic source based at least in part on a historical search condition corresponding to the current traffic source.

4. The system of claim 1, wherein the conversion event includes one or more of the following: purchasing of an item at a designated website, registering as a new member at the designated website, forwarding a page associated with an item at the designated website, and bookmarking a page associated with the designated website.

5. The system of claim 1, wherein the predetermined benchmark conversion rate is determined based at least in part on a historical conversion rate of on-site traffic of a designated website.

6. The system of claim 1, wherein the one or more processors are further configured to is submit the selected piece of advertising information as a bid to an advertising selection system associated with the current traffic source, wherein the advertising selection system associated with the current traffic source is configured to determine whether to display the selected piece of advertising information with search results to be displayed for the current search condition.

7. The system of claim 1, wherein the one or more processors are further configured to determine the selection model based at least in part on historical advertising feedback data associated with the current traffic source.

8. The system of claim 1, wherein the one or more processors are further configured to determine the conversion model based at least in part on historical advertising feedback data associated with the current traffic source.

9. A method, comprising:
determining that a current search condition is received at a current traffic source;
determining a set of advertising information relevant to the current search condition from an advertising database associated with the current traffic source;
determining a predicted probability of a first piece of the set of advertising information being selected by a user based at least in part on inputting the current search condition into a selection model;
determining a predicted probability that user selection of the first piece of the set of advertising information gives rise to a conversion event based at least in part on inputting the current search condition into a conversion model;
determining, using one or more processors, an attribute parameter for the first piece of the set of advertising information based at least in part on the predicted probability of being selected by the user, the predicted probability that user selection gives rise to the conversion event, and a predetermined benchmark conversion rate;
determining a ranked list of the set of advertising information based at least in part on each piece of advertising information's respective attribute parameter; and
selecting a selected piece of advertising information from the set of advertising information based at least in part on the ranked list to be potentially displayed at the current traffic source.

10. The method of claim 9, wherein the current traffic source comprises an external traffic source associated with a designated website.

11. The method of claim 9, further comprising determining the advertising database associated with the current traffic source including by:
obtaining traffic information associated with web traffic from a plurality of traffic sources to a designated website, wherein the traffic information includes at least a historical search condition corresponding to each of the plurality of traffic sources, wherein the plurality of traffic sources includes the current traffic source;
creating the advertising database for the current traffic source; and
mapping one or more pieces of advertising information from a predetermined foundation database to the advertising database corresponding to the current traffic source based at least in part on a historical search condition corresponding to the current traffic source.

12. The method of claim 9, wherein the conversion event includes one or more of the following: purchasing of an item at a designated website, registering as a new member at the designated website, forwarding a page associated with an item at the designated website, and bookmarking a page associated with the designated website.

13. The method of claim 9, wherein the predetermined benchmark conversion rate is determined based at least in part on a historical conversion rate of on-site traffic of a designated website.

14. The method of claim 9, further comprising submitting the selected piece of advertising information as a bid to an advertising selection system associated with the current traffic source, wherein the advertising selection system associated with the current traffic source is configured to determine whether to display the selected piece of advertising information with search results to be displayed for the current search condition.

15. The method of claim 9, further comprising determining the selection model based at least in part on historical advertising feedback data associated with the current traffic source.

16. The method of claim 9, further comprising determining the conversion model based at least in part on historical advertising feedback data associated with the current traffic source.

17. A computer program product, the computer program product being embodied in a non-transitory computer readable storage medium and comprising computer instructions for:
determining that a current search condition is received at a current traffic source;
determining a set of advertising information relevant to the current search condition from an advertising database associated with the current traffic source;
determining a predicted probability of a first piece of the set of advertising information being selected by a user based at least in part on inputting the current search condition into a selection model;
determining a predicted probability that user selection of the first piece of the set of advertising information gives rise to a conversion event based at least in part on inputting the current search condition into a conversion model;
determining an attribute parameter for the first piece of the set of advertising information based at least in part on the predicted probability of being selected by the user, the predicted probability that user selection gives rise to the conversion event, and a predetermined benchmark conversion rate;
determining a ranked list of the set of advertising information based at least in part on each piece of advertising information's respective attribute parameter; and
selecting a selected piece of advertising information from the set of advertising information based at least in part on the ranked list to be potentially displayed at the current traffic source.

18. The computer program product of claim 17, wherein the current traffic source comprises an external traffic source associated with a designated website.

19. The computer program product of claim 17, further comprising determining the advertising database associated with the current traffic source including by:
obtaining traffic information associated with web traffic from a plurality of traffic sources to a designated website, wherein the traffic information includes at least a historical search condition corresponding to each of the plurality of traffic sources, wherein the plurality of traffic sources includes the current traffic source;
creating the advertising database for the current traffic source; and
mapping one or more pieces of advertising information from a predetermined foundation database to the advertising database corresponding to the current traffic source based at least in part on a historical search condition corresponding to the current traffic source.

20. The computer program product of claim 17, wherein the conversion event includes one or more of the following: purchasing of an item at a designated website, registering as a new member at the designated website, forwarding a page associated with an item at the designated website, and bookmarking a page associated with the designated website.
